(19) United States
(12) Patent Application Publication
(10) Pub. No.: US 2010/0282876 A1
(43) Pub. Date: Nov. 11, 2010

(54) ADJUSTABLE LANCE SPRAY ASSEMBLY

(75) Inventors: Peter M. Bonnevie, Richmond, VA (US); Robert B. Fitts, Merrimack, NH (US); Charles J. Zaverson, Hudson, NH (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: SPRAYING SYSTEMS CO., Wheaton, IL (US)

(21) Appl. No.: 12/812,481

(22) PCT Filed: Jan. 15, 2009
(86) PCT No.: PCT/US09/31091

§ 371 Date: Jul. 28, 2010

Related U.S. Application Data
(60) Provisional application No. 61/011,146, filed on Jan. 15, 2008.

(51) Int. Cl. B05B 1/00

(52) U.S. Cl. 239/589

(57) ABSTRACT

A spraying assembly is provided that includes a support member and a pair of lance spray devices supported by the support member. Each lance spray device includes a lance body having an inlet end and a downstream end and a spray nozzle arranged at the downstream end of the lance body. The pair of lance spray devices are configured and supported by the support member such that at least one of the pair of lance spray devices is movable relative to the other of the pair of lance spray devices between at least first and second relative positions with the spray nozzles of the pair of lance spray devices being spaced relatively closer together in the first position than in the second position.

### CROSS-REFERENCE TO RELATED APPLICATIONS

This patent application claims the benefit of U.S. Provisional Patent Application No. 61/011,146, filed Jan. 15, 2008, which is incorporated by reference.

### BACKGROUND OF THE INVENTION

Tanks and other types of enclosed vessels are used in a variety of different of industrial processes. Such tanks generally must be cleaned on a periodic basis. However, access into the tanks is often quite limited. One way in which to clean the tanks is to insert a spraying device into the tank through an access opening. The spraying device can then be used to discharge a cleaning fluid onto the interior walls of the tank.

A significant problem with such an approach is that there are often obstructions such as pipes in the interior of the tank that limit the ability of the spray device to completely clean the interior of the tank. In particular, the obstructions produce so-called “shadowing” or “shadows” on the interior walls of the tank, i.e. areas on the interior walls of the tank that are not reached by the cleaning fluid. This occurs because the cleaning fluid discharging from the spray device impinges on the obstruction, creating a shadow behind the obstruction on the interior wall of the tank where the cleaning fluid does not reach. As a result, the interior walls of the tank are not completely cleaned.

### BRIEF SUMMARY OF THE INVENTION

The invention provides a spraying assembly that includes a support member and a pair of lance spray devices supported by the support member. Each lance spray device includes a lance body having an inlet end and a downstream end and a spray nozzle arranged at the downstream end of the lance body. The pair of lance spray devices are configured and supported by the support member such that at least one of the pair of lance spray devices is movable relative to the other of the pair of lance spray devices between at least first and second relative positions with the spray nozzles of the pair of lance spray devices being spaced relatively closer together in the first position than in the second position.

### BRIEF DESCRIPTION OF THE SEVERAL VIEWS OF THE DRAWING(S)

FIG. 1 is a side view of an illustrative lance spray assembly according to the invention with the lance spray devices in the closed position.

FIG. 2 is another side view of the lance spray assembly of FIG. 1 with the lance spray devices in the closed position.

FIG. 3 is a side view of the lance spray assembly according to FIG. 1 showing the lance spray devices in the open or deployed position.

FIG. 4 is a top view of the lance spray assembly according to FIG. 1 shown the lance spray devices in the open or deployed position.

FIG. 5 is a side sectional view of the spray assembly according to FIG. 1 taken in the plane of line 5-5 in FIG. 4.

FIG. 6 is an enlarged side sectional view of the rotary joint between the support member and one of the lance spray devices of the lance spray assembly of FIG. 1.

FIG. 7 is a schematic top view showing the operation of the lance spray assembly of the present invention in an exemplary tank.

### DETAILED DESCRIPTION OF THE INVENTION

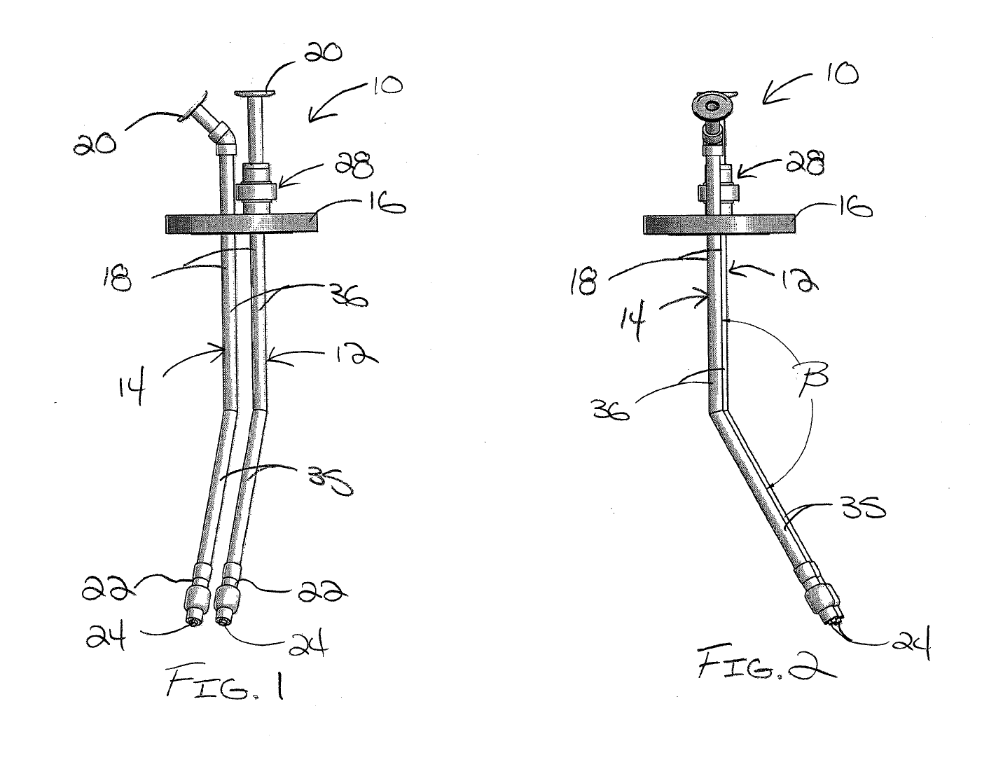

Referring now to FIGS. 1 and 2 of the drawings, a lance spray assembly 10 in accordance with the invention is shown. The lance spray assembly 10 includes, in this case, two lance spray devices 12, 14 that are supported by a disc-shaped support member 16. While the spray assembly of the present invention is described below in the context of a tank cleaning or washing application, those skilled in the art will appreciate that the invention is not limited to such applications. In particular, the lance spray assembly of the present invention can be used in any application in which it is necessary to spray a fluid around an obstruction.

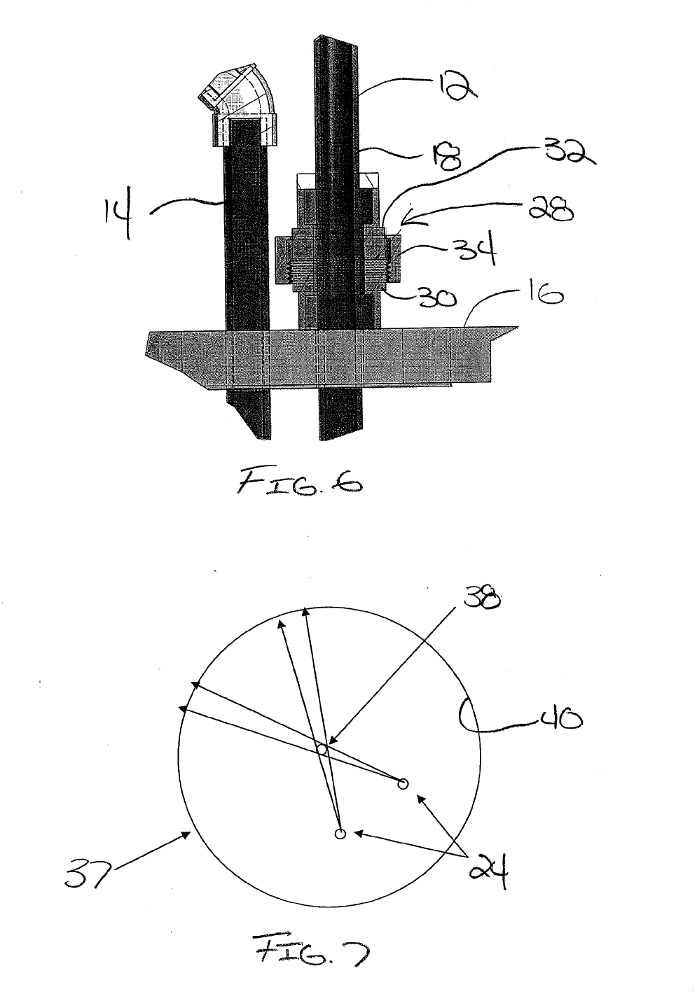

In the illustrated embodiment, each lance spray device 12, 14 includes an elongated lance body 18 that extends through the support member 16 and has an upstream end 20 including an inlet fitting arranged above the support member 16 and a downstream, outlet end 22 arranged below the support member 16. In this case, the inlet fitting provides a connection for a cleaning fluid supply. The outlet end 22 of the lance body 18 includes a nozzle holder for supporting a spray nozzle 24 for discharging the cleaning fluid. An interior fluid passageway 26 (see FIG. 5) extends through the lance body 18 between the inlet and outlet ends 20, 22 of the lance body in order to direct the cleaning fluid from the inlet to the spray nozzle 24 at the outlet end of the lance body.

Any spray nozzle capable of producing the desired spray characteristics can be connected to the lance body. Typically, the spray nozzle will be selected based on a number of factors including the cleaning fluid being used, the size of the tank being cleaned and the desired spray pattern and flow rate. One example of appropriate spray nozzles are the tank washing nozzles sold by Spraying Systems Co. of Wheaton, Ill., the assignee of the present invention.

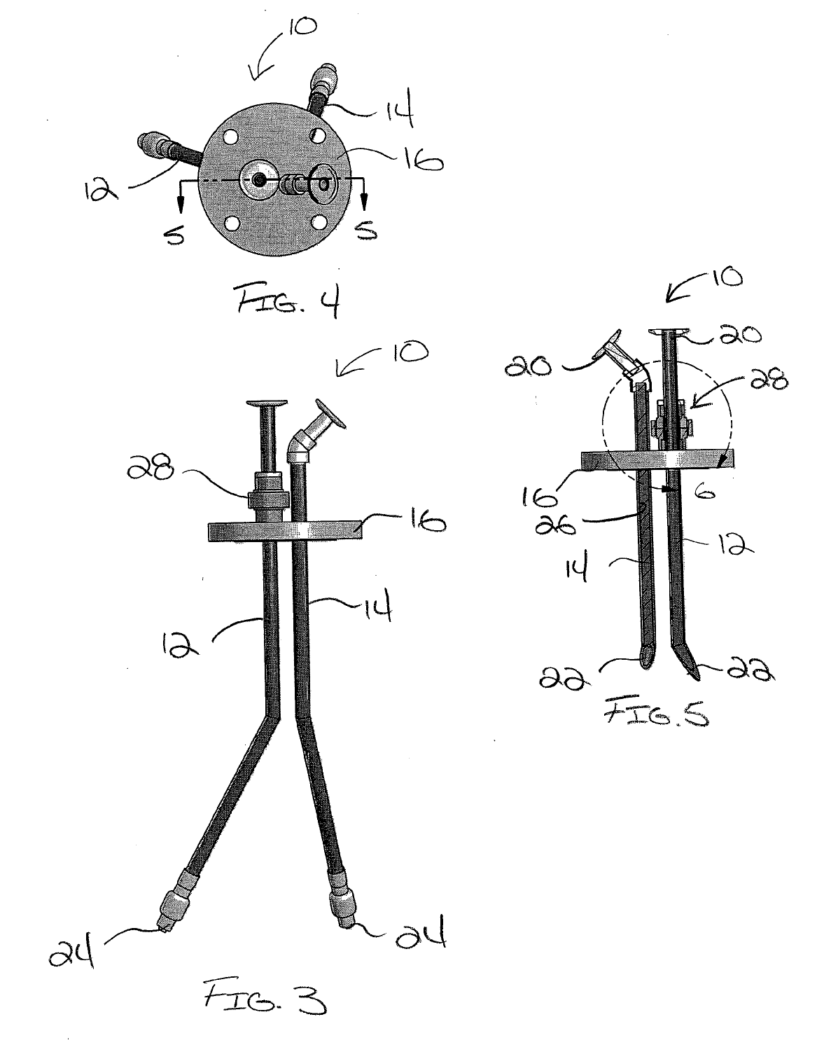

In accordance with an important aspect of the present invention, the lance spray devices 12, 14 are movable relative to each other between a closed position wherein their respective nozzles 24 are arranged close together for insertion of the spray assembly 10 into the tank (see FIGS. 1 and 2) and an open position wherein the spray nozzles 24 are spaced apart such that they can be arranged on either side of an obstruction in the tank (see FIGS. 3 and 4). Arranging the spray nozzles 24 on either side of the obstruction prevents the obstruction from producing a shadow on the interior wall of the tank behind the obstruction (relative to the positions of the nozzles) that the cleaning fluid is unable to reach. Thus, as compared to tank cleaning nozzle arrangements including only a single cleaning nozzle, the spray assembly 10 of the present invention that includes at least two lance spray devices 12, 14 is able to clean the entire interior wall of the tank. In this regard, while the illustrated embodiment includes two lance spray devices 12, 14 and two spray nozzles 24, those skilled in the art will understand that the spray assembly of the present invention could have additional lance spray devices and nozzles.

To this end, in the illustrated embodiment, one of the lance spray devices (referred to herein as the first lance spray device 12) is received in the support member 16 such that it can pivot or rotate relative to the support member 16 about the longitudinal axis of the section of the lance body 18 that passes through the support member 16. In this case, the other lance spray device (referred to herein as the second lance spray device 14) is fixed, such as by welding, relative to the support member 16. Thus, pivoting the first lance spray device 12 relative to the support member 16 also moves the first lance spray device 12 relative to the second lance spray device 14. As will be appreciated, if desired, both lance spray devices 12, 14 could be pivotable relative to the support member 16.

To facilitate the rotating or pivoting movement of the first lance spray device, the illustrated first lance spray device 12 is connected to the support member 16 using a rotary joint 28 that can be selectively locked in a desired position. As shown in FIG. 6, the rotary joint 28, in this instance, includes a metal seat 30 that is fixed to the support member 16 and through which the lance body 18 of the first lance spray device 12 extends and a collar 32 that, in turn, is fixed to the lance body 18. A nut 34 is provided that when tightened can secure the collar 32 on the lance body 18 to the metal seat 30 so as to prevent pivoting of the lance body 18 relative to the seat 30 and support member 16. When the nut 34 is loosened, the first lance spray device 12 is free to pivot in the seat so that the first lance spray device can be moved into a desired position for a cleaning operation. As will be appreciated, the illustrated rotary joint 28 is only one example of a rotary joint that could be used for connecting the first lance spray device 12 to the support member 16 and that any suitable rotary joint that allows the desired pivoting motion could be used.

So that pivoting of the first lance spray device 12 relative to the second lance spray device 14 produces a spatial separation at the outlet ends 22 of the lance bodies 18 where the spray nozzles 24 are arranged, at least the pivotable first lance spray device 12, and in this case, both lance spray devices 12, 14 have lance bodies 18 that are angled. In particular, as best shown in FIG. 2, the lower section 35 of both of the lance bodies 18 is configured at an angle β to the center section 36 of the lance body that passes through the support member 16. Thus, in the case of the pivotable first lance spray device 12, the lower section 35 of the lance body which carries the spray nozzle 24 is at an angle relative to the pivoting axis of the lance spray assembly. As a result, when the first lance spray device 12 is pivoted, a significant separation is produced between the spray nozzles 24 of the first and second lance spray devices 12, 14. In this case, to facilitate connection of the lance spray devices 12, 14 to the fluid supplies, a portion of the upstream, inlet end 20 of the body 18 of the second lance spray assembly 14 is also angled relative to the center section 36 of the body while the inlet end 20 of the first lance spray assembly 12 is inline with the center section 36.

Referring to FIG. 7, in use, the spray assembly 10 is inserted into a tank or vessel 37 to be cleaned with the two lance spray devices 12, 14 in the closed position, that is with the spray nozzles 24 of the two lance spray devices at least as close together as is necessary to insert the downstream ends of the lances through the appropriate access opening in the tank 37. Once the downstream, outlet ends 22 of the lance spray devices 12, 14 are sufficiently inserted into the tank 17, the spray assembly 10 can be opened by pivoting, in this case, the first lance spray device 12 relative to the second lance spray device 14. This pivoting movement substantially enlarges the distance between the spray nozzles 24 carried by the first and second lance spray devices 12, 14. Once the spray nozzles have been spread apart, the spray assembly 10 can be arranged with each nozzle 14 on a respective side of an obstruction 38 in the tank 37 as shown in FIG. 7. In this way, the shadow produced by the obstruction 38 in the discharge of each of the nozzles 24 is covered by the discharge from the other nozzle 24. Thus, cleaning fluid can be directed on the entire interior wall 40 of the tank 37.

All that is necessary to move the lance spray devices 12, 14 to the open position is to pivot the first lance spray device 12 enough to spread apart the spray nozzles 24 of the two lances 12, 14 a sufficient distance to enable the nozzles to be arranged on either side of the obstruction and thereby eliminate any shadowing. Thus, the amount of movement necessary to reach the open position may change based on the size and shape of a particular obstruction, i.e. with smaller obstructions the nozzles may only need to spaced apart a small distance where with larger obstructions a larger spacing of the nozzles may be required.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A spraying assembly comprising:
a support member; and
a pair of lance spray devices supported by the support member, each lance spray device including a lance body having an inlet end and a downstream end and a spray nozzle arranged at the downstream end of the lance body;
the pair of lance spray devices being configured and supported by the support member such that at least one of the pair of lance spray devices is movable relative to the other of the pair of lance spray devices between at least first and second relative positions with the spray nozzles of the pair of lance spray devices being spaced relatively closer together in the first position than in the second position.

2. The spraying assembly of claim 1 wherein the at least one of the pair of lance spray devices that is moveable is pivotally supported on the support member.

3. The spraying assembly of claim 2 wherein the at least one of the pair of lance spray device that is moveable is connected to the support member via a rotary joint.

4. The spray assembly of claim 3 wherein the rotary joint is lockable when the pair of lance spray devices are in the first and second relative positions.

4. The spray assembly of claim 1 wherein at least one of the pair of lance spray devices has a non-linear configuration.

5. The spray assembly of claim 1 wherein each of the pair of lance spray devices has a non-linear configuration.

6. The spray assembly of claim 4 wherein the lance body of the at least one of the pair of lance spray devices having a non-linear configuration includes a lower section that extends at an angle to an upper section that passes through the support member.

7. The spray assembly of claim 5 wherein the lance body of each of the pair of lance spray devices includes a lower section that extends at an angle to an upper section that passes through the support member.
